(19) United States
(12) Patent Application Publication
(10) Pub. No.: US 2013/0120978 A1
(43) Pub. Date: May 16, 2013

(54) FLASHLIGHT WITH A CONTACT SPRING

(71) Applicant: Rainer Opolka, Solingen (DE)

(72) Inventor: Rainer Opolka, Solingen (DE)

(21) Appl. No.: 13/695,244

(22) PCT Filed: May 4, 2011
(86) PCT No.: PCT/DE2011/001023

§ 371 Date: Dec. 21, 2012

(30) Foreign Application Priority Data
Jul. 6, 2010 (DE) 10 2010 026 160.2
Sep. 3, 2010 (EP) 10175175.8

(51) Int. Cl. F21L 4/00

(52) U.S. Cl. CPC F21L 4/00
USPC 362/203; 362/202

(57) ABSTRACT

The present invention relates to a flashlight with a cylindrical battery housing at the end of which an electrically conductive contact surface is formed, an end cap, and a contact spring with contact points which connects a pole of a battery mounted in the battery housing to the contact surface of the battery housing. In order to reduce contact points and also enable secure and stable electrical contact, according to the invention it is provided that the contact points are arranged at opposite ends of the contact spring.

The present invention relates to a flashlight with a cylindrical battery housing at the end of which an electrically conductive contact surface is formed, an end cap, and a contact spring with contact points which connects a pole of a battery mounted in the battery housing to the contact surface of the battery housing.

A flashlight of this type is described, for example, in DE 20 2007 009 202.4. It has an end cap, in which a pressure spring is arranged that consists of a single piece of spring wire with a winding diameter that is different in some regions, a plurality of windings being arranged radially next to one another at least partly. In other words, a pressure spring is described that has two coaxially mounted portions that are each designed as helical springs. The end pieces of the contact springs, situated partly radially next to each other, form the contact points, wherein one contact point is connected to the pole of a battery and the other contact point is connected to a contact surface of the battery housing.

This document already discloses that a plurality of contact points in a circuit of a flashlight adversely affect the ability to use it because the electrical contacts do not form an optimal electrical contact at contact points because of oxidation, dirt and wear phenomena, with the result that solutions have been sought for reducing the number of contact points. The flashlights described in DE 20 2007 009 272.4 have end caps with a pressure spring which have just two contact points for an electrical contact, namely between the battery pole and spring and between the spring and the battery housing. It is not possible to reduce this number of contact points in a multi-part disassemblable design. However, the proposed design has the disadvantage that it is comparatively complicated to produce the required pressure spring, which, on the one hand, entails relatively high costs and, on the other hand, requires precision work when the pressure spring is being produced.

The object of the present invention is therefore to create a flashlight with an end cap, which can be produced simply with the smallest possible number of required contact points, as a result of which, on the one hand, production costs are reduced and, on the other hand, a stable electrical contact is created.

This object is achieved by the flashlight as claimed in claim 1, wherein according to the invention the contact points are arranged at opposite ends of the contact spring. In other words, a flashlight is proposed that has a contact spring in its end cap, is wherein the contact spring has contact points, at two opposite ends, that can be connected, on the one hand, to the pole of a battery and, on the other hand, to the contact surfaces of the battery housing. The contact spring is hereby preferably designed as a helical or leaf spring, but other types of contact spring can also be envisaged.

In principle, three different embodiments of the present invention are provided, which are explained below and in the subclaims.

According to a first preferred embodiment, it is provided that the end cap has an external thread and the battery housing has a corresponding internal thread, and that the contact spring has, at its end, at least one radial portion that engages in a recess of the end cap in such a way that the portion is connected to the contact surface of the battery housing in the assembled state. To do this, the portion must protrude from the recess by a certain amount so that the protruding portion can be pressed against the contact surfaces of the battery housing. In principle, the contact surface can be arranged in the form of a ring or part-ring on the end side of the battery housing. As an alternative, the contact surface can also be designed as a base in the form of a ring or part-ring inside the battery housing. The recess is preferably arranged between the thread of the end cap and a closing piece. At this point, it is particularly simple to introduce the recess into the end cap through a bore.

According to an alternative embodiment of the present invention, it is provided that the end cap has an internal thread and the battery housing a corresponding external thread, and that the contact spring has, at its end, at least in a portion, a radius that is so large that this portion is connected to the contact surface of the battery housing in the installed state. To do this, the contact spring is preferably a helical spring that is preferably designed with a frustoconical shape. The frustoconical helical spring here preferably has at its end a portion with a radius that is so large that this portion is connected to the contact surface of the battery housing in the installed state. Put differently, the pointed end of the contact spring is connected to the battery and the wider end is connected to the end cap or the contact surface, so that a circular linear contact is formed. This embodiment can be configured particularly readily as a switch because the contact can be closed by turning the end cap owing to linear contact between the contact spring and battery housing. It is moreover provided that the end cap can be screwed onto the battery housing to an extent such that the contact is not yet closed, so that a contact can be closed using the play in the thread, as a result of which this embodiment can also be designed as a momentary-on button.

According to a further preferred embodiment of the present invention, it is provided that the contact spring has a radial portion that is connected in one or two pieces to a clip, the contact being established by turning the end cap. Moreover, according to a further embodiment, it is provided that there is a gap between the portion and the contact surface in the installed state, so that the contact is closed by pivoting motion of the clip. The abovementioned advantages in terms of the design of the switch result in both embodiments because here too the end cap can be turned to such an extent that the contact can be closed either by a turning motion of the end cap or by pressure using the play in the thread.

The clip is preferably arranged along the longitudinal axis on the battery housing. This flashlight can be adjusted by is turning the end cap in such a way that a contact is closed by slight pressure on or pivoting of the clip and the contact is broken again by pulling in the opposite direction. It is hereby even possible to adjust the flashlight in such a way that the contact is broken when the flashlight is suspended from the clip in a pocket, for example a breast pocket, and the circuit is closed as soon as the flashlight is removed from the pocket.

Specific embodiments and further preferred developments of the present invention are explained below with the aid of the drawings, in which:

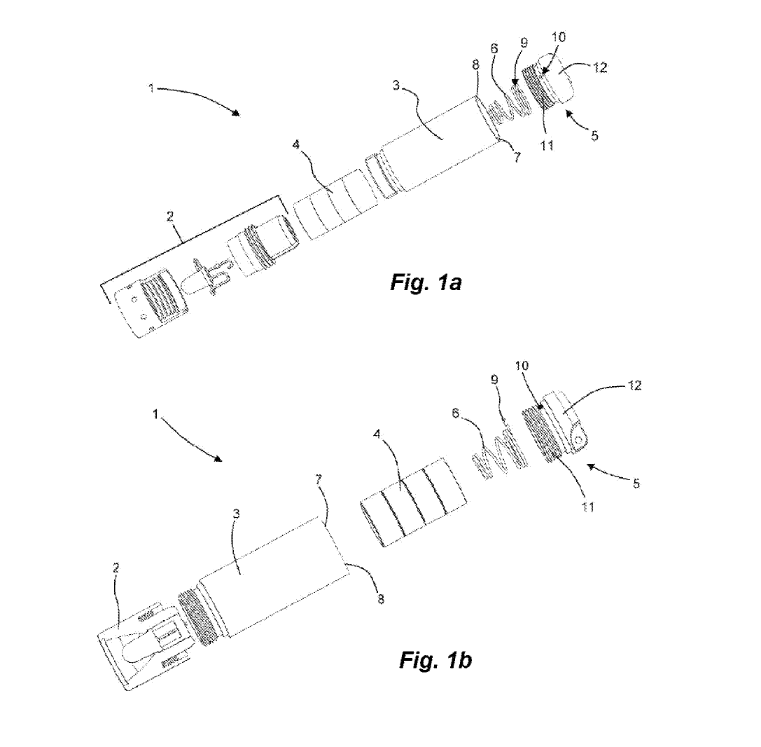

FIGS. 1a, b each show an exploded view of a flashlight,

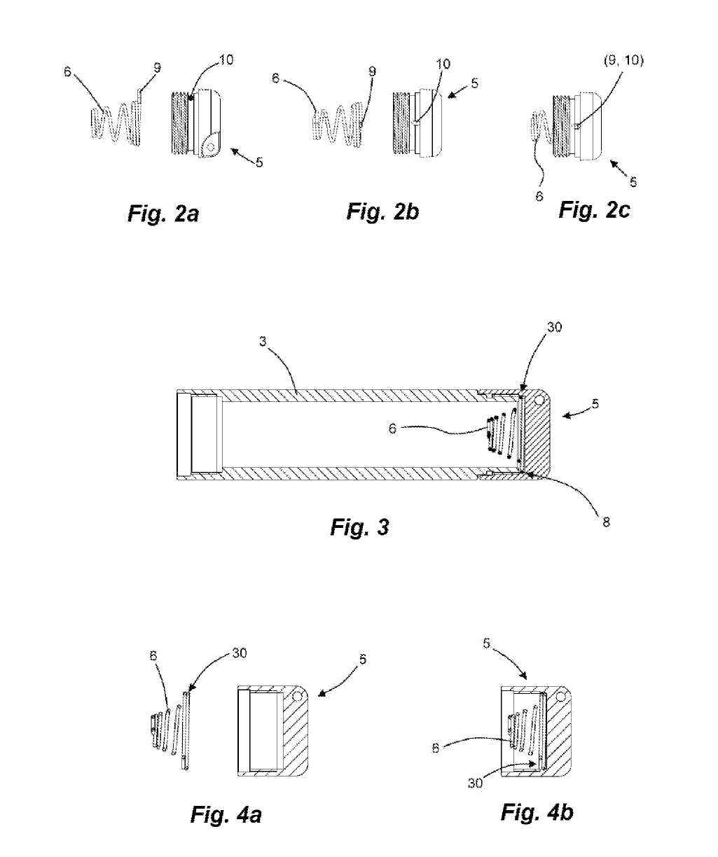

FIGS. 2a, b, c each show an end cap with a helical screw,

FIG. 3 shows a flashlight with a frustoconical contact spring,

FIGS. 4a, b each show an end cap with a spring having a widened portion,

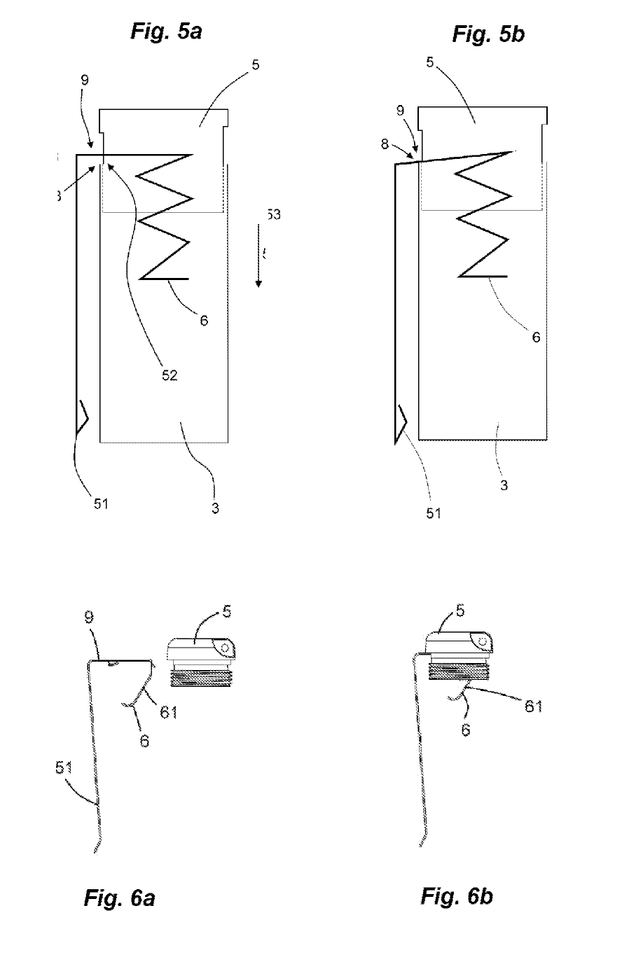

FIGS. 5a, b each show a flashlight with a clip, and

FIGS. 6a, b, c show a further embodiment of a flashlight with a clip that is connected to a leaf spring.

An exploded view of a flashlight 1 with a lamp head 2, a battery housing 3, batteries 4, an end cap 5, and a contact spring 6 in the form of a helical spring is shown in each of FIGS. 1a and 1b. In such flashlights, the circuit is usually closed by the battery housing 3, for which purpose the latter is made at least partially from a conductive material. Aluminum is the preferred material, which can be treated with an anodizing process to harden the surface. In such a case, the treated surface must, however, be polished to create an electrical contact surface, the end side 7 of the battery housing preferably being used for this so that it can be used as a contact surface 8. To make contact between the battery and the battery housing, the contact spring 6 is provided having at its end a radial portion 9 that can be introduced into a recess 10 in such a way that it projects from the recess 10 by a certain amount. FIGS. 2a to c each show a detailed view of an end cap 5 with a recess 10 and a contact spring 6, FIG. 2c showing the end cap 5 with an installed contact spring 6. In order to close the electrical contact, the end cap 5 must be screwed, together with the projecting radial portion 9, so far into the battery housing that the radial portion 9 comes to bear against the contact surface 8. Particularly suited for such a design is an end cap with an external thread 11 and a battery housing 3 with a corresponding internal thread.

FIG. 3 shows an alternative design in which a contact spring 6 is used that has a wider radius at its end (arrow 30). As a result, a circular linear contact is created that can be connected to an annular contact surface 8 on the battery housing. An end cap 5 with an internal thread and a battery housing 3 with an external thread are preferably used for such a design.

FIGS. 4a and b show a detailed view of the end cap 5 with a contact spring 6, the contact spring 6 having a wider radius at its end (arrow 30).

According to a further embodiment of the present invention, it is provided that the radial portion 9 is connected to a clip 51, there being a gap 52 between the portion 9 and the contact surface 8 in the installed state, such that the contact is closed by a pivoting motion of the clip 51 (FIGS. 5a, b). The clip 51 is preferably arranged on the longitudinal axis of the battery housing 3. This flashlight can be adjusted by turning the end cap 5 such that a contact is closed by slight pressure or pivoting of the clip 51 in the direction of the arrow 53 (cf. FIG. 5b) and the contact is broken again by pulling in the opposite direction.

FIGS. 6a, b and c show other embodiments of a flashlight, the contact spring 6 here being designed as a leaf spring 61. In addition, the leaf spring 61 is also integrally connected to a clip 51. In the assembled state (FIG. 6c), an electrical contact 62 to a battery 4 is provided at the end of the leaf spring 61. Another electrical contact 63 is arranged on the radial portion 9 that merges integrally into the clip 51. The contact 63 can also be closed by turning the end cap 5 or by applying slight pressure to the latter, wherein the end cap must be screwed on correspondingly far to do this.

1. A flashlight comprising:
a cylindrical battery housing at the end of which an electrically conductive contact surface is formed,
an end cap, and
a contact spring having contact points engaging and connecting together a pole of a battery mounted in the battery housing and the contact surface of the battery housing, the contact points being at opposite ends of the contact spring.

2. The flashlight as claimed in claim 1, wherein the contact spring is a helical spring or a leaf spring.

3. The flashlight as claimed in claim 1, wherein the end cap has an external thread and the battery housing has a complementary internal thread, and the contact spring has, at its end, at least one radial portion that engages in a recess of the end cap in such a way that the portion is connected to the contact surface of the battery housing in the assembled state.

4. The flashlight as claimed in claim 3, wherein the recess is between the external thread of the end cap and a closing piece.

5. The flashlight as claimed in claim 1, wherein the end cap has an internal thread and the battery housing a complementary external thread, and the contact spring has, at its end, at least in a portion, a radius that is so large that this portion is connected to the contact surface of the battery housing in the installed state.

6. The flashlight as claimed in claim 1, wherein the contact spring is a helical spring of frustoconical shape.

7. The flashlight as claimed in claim 6, wherein the frustoconical helical spring has at each of its end a portion with a radius that is so large that this portion is connected to the contact surface of the battery housing in the installed state.

8. The flashlight as claimed in claim 1, wherein the contact spring has a radial portion that is connected in one or two pieces to a clip, the contact being established by turning the end cap.

9. The flashlight as claimed in claim 8, wherein there is a gap between the portion and the contact surface in the installed state, so that the contact is closed by a pivoting motion of the clip.

10. The flashlight as claimed in claim 8, wherein the clip is extends along a longitudinal axis of the battery housing.
